(19) United States
(12) Patent Application Publication
(10) Pub. No.: US 2006/0149430 A1
(43) Pub. Date: Jul. 6, 2006

(54) Entertainment device storage case adapted for interconnection to a vehicle seat

(76) Inventor: Robin R. Slaton, Fort Collins, CO (US)

Correspondence Address: SHERIDAN ROSS PC, 1560 BROADWAY, SUITE 1200, DENVER, CO, 80202, US

(21) Appl. No.: 11/325,255

(22) Filed: Jan. 3, 2006

Related U.S. Application Data
(60) Provisional application No. 60/641,203, filed on Jan. 3, 2005.

(51) Int. Cl. G05D 1/00

(52) U.S. Cl. 701/1

(57) ABSTRACT

A storage case that is adapted to secure an entertainment device, such as a portable DVD player is provided. The storage case may be equipped with a plurality of mechanisms that allow selective interconnection to a seat of a vehicle to facilitate use of the entertainment device and includes an orientation mechanism that allows the selective orientation of the storage case for improved storage. Preferably, the storage case also contains a plurality of additional pockets or compartments for securing periphery items that are generally used with the stored entertainment device, and which are removable.

This application claims priority to U.S. Provisional Patent Application Ser. No. 60/641,203, filed Jan. 3, 2005, which is incorporated by reference in its entirety herein.

### FIELD OF THE INVENTION

The present invention relates to a storage case for securing an entertainment device, such as a portable DVD player or a lap top computer. More specifically, one embodiment of the present invention is adapted for interconnection to at least one seat generally found in a vehicle, such as an automobile, and alternatively for positioning between two seats.

### BACKGROUND OF THE INVENTION

It is sometimes desirous to entertain passengers and especially children seated in the rear compartment of a vehicle. In addition, often passengers in the rear compartment find it difficult to hear and understand passengers seated in the front compartment of the vehicle, thereby making a conversation difficult. Thus, passengers in the rear compartment of the vehicle choose to pass time by using an entertainment device such as a portable television, VCR, DVD player, cassette tape player, computer, computer game, etc. (hereinafter “entertainment device” or “DVD Player”).

Many jurisdictions dictate that children be seated in the rear compartment of an automobile to prevent serious injury due to a collision or from the deployment of airbags, which are generally located in the front compartment of the vehicle. Since children are usually seated in the rear compartment of the vehicle, interaction with the driver is impractical and often dangerous. Alternatively, if two people are riding in the vehicle, one must sit in the rear to tend to the child, making conversation therebetween distracting and difficult. As most parents will appreciate, children tend to become bored without a sufficient amount of stimulation when traveling on long car trips, which can lead to distraction of the operator of the vehicle if the child becomes disruptive. Many modern vehicles employ entertainment devices to occupy children, either integrated into the ceiling or front seats thereof. Although entertainment devices provide children with sufficient stimulation during a trip, many consumers cannot afford a vehicle that includes these types of amenities. Thus, the child is left to his or her own devices to entertain themselves during a long journey, which may lead to disruptive behavior.

Entertainment devices have been transported in vehicles in the past. Often, for example, the entertainment device is simply placed on a console of the vehicle. One drawback of this method of transporting entertainment devices is that sudden stops or turns will certainly turn the unsecured entertainment device into a dangerous projectile inside the vehicle, which may potentially harm the passengers or driver.

A related drawback to simply transporting an unsecured entertainment device in the rear compartment of an automobile is that upon sudden stops and turns the expensive entertainment devices may be damaged. Thus, it is impractical, dangerous and potentially expensive to utilize electronic devices in a vehicle without some form of restraint device or protective case.

A second related drawback to simply transporting an unsecured entertainment device in the rear portion of the vehicle is that there is often no convenient area for the storage of media generally used with the entertainment device. This drawback may lead to a disorganized or messy vehicle, especially during long trips. In addition, expensive media such as DVDs, computer games, etc., may become damaged because they are not properly stored during a long trip.

Finally, although certain types of electronic carrying cases and suspension systems have been designed in the past, generally these cases are designed for use either behind a seat or between two seats, but are not adapted for both types of uses.

There is a further need in the storage of entertainment devices such as DVD players to allow the mechanism to be quickly interconnected to a suspension system in a vehicle, while further allowing the case to be detached and carried to a secondary location. Furthermore, there is a need for an entertainment storage device which can be suspended at the rear portion of a vehicle seat and which has an adjustment mechanism which allows the viewing angle of the entertainment device to be quickly modified to a viewer's preference and which can be used by small children and others.

Thus, there is a long felt need in the field of entertainment device storage to provide a device that is adapted to secure an electronic device, and in addition interconnect to at least one seat of a vehicle, or alternatively between two seats, and thus providing a safe and easily accessible storage location for an entertainment device. The following disclosure describes a device that is adapted for interconnection to one or two seats of a vehicle, such as an automobile or an airplane, wherein a compartment is provided that secures an entertainment device such as a portable DVD player or a lap top computer.

### SUMMARY OF THE INVENTION

It is one aspect of the present invention to provide a storage case that secures an entertainment device. More specifically, one embodiment of the present invention is secures an entertainment device such as a television, a VCR, a portable DVD player, a CD player, a computer game, a computer, etc. (hereinafter an Aentertainment device@ or ADVD player@). This embodiment of the present invention generally includes a base portion that supports the entertainment device and a closure portion that is operably interconnected to the base portion, thus totally enveloping the entertainment device for protection. In addition, the closure portion and/or base portion may include a plurality of pockets or compartments for securing periphery items that are generally used with the entertainment device. In addition, this embodiment of the present invention also includes at least one handle that aids in the transportation of the case and entertainment device.

It is another aspect of the present invention to provide a storage case for entertainment devices that is easily and quickly interconnected to at least one seat of a vehicle, and alternatively two seats with the addition of minimal attachment hardware. More specifically, one embodiment of the present invention includes a plurality of buckles that are adapted for interconnection with securing devices, such as straps, which are in turn interconnected to straps for attachment to at least one seat or headrest in the vehicle. Thus, the storage case may be suspended between two bucket seats of the vehicle, or alternatively may be interconnected to the rear portion of the seat to provide viewing for occupants sitting in the rear portion of the vehicle. In addition, the use of straps with securing devices for selective interconnection to the case make the present invention quickly deployable in any situation, thus making it easy to use and transport.

It is yet another aspect of the present invention to provide a storage case for an entertainment device that is safe and provides protection to the entertainment device. Preferably, one embodiment of the present invention is constructed from cushioned components such that any impact will cause little damage. In addition, the present invention is designed for selective interconnection to one or more seats within a vehicle, thereby restricting movement and providing an improved viewing experience for the user.

It is a related aspect of the present invention to provide a storage case for entertainment devices that protects the device contained therein. More specifically, one embodiment of the present invention employs padded compliant materials, wherein the entertainment device is sufficiently protected from impacts. Alternatively, as it will be understood by one skilled in the art, the device of the present invention may be constructed of a more rigid material that will provide increased protection from impacts. One embodiment of the present invention, as described briefly above, is constructed of a base portion and a cover portion, which are selectively interconnected thereto with a securing device, such as a zipper. However, other selectively interconnecting means may be used without departing from the scope of the invention, such as zip locks, snaps, velcro, etc. The securing mechanism between the cover portion and the base portion may also include a mechanism that helps prevent the infiltration of fluids inside the case, which may damage delicate electronic componentry.

It is still yet another aspect of the present invention to provide a storage case that includes a storage location for media or other items generally used with the entertainment device. More specifically, one embodiment of the present invention employs a plurality of pockets or storage compartments that secure items such as CDs, DVDs, tapes, games, disks, books, manuals, magazines, pens, pencils, markers, etc. It should be understood by one skilled in the art that the list of items that may be stored by the present invention is not exhaustive, for example periphery components such as cords, disc drives, speakers, MP3 players, keyboards, mice, data storage devices, wireless network detectors, cellular phones, earphones, etc. may be stored inside the case without departing from the scope of the invention. Further, the pockets used and described herein may be customized for the items they are carrying such as slots for securing a DVD, for example, and may be removable in one embodiment of the invention.

It is yet another aspect of the present invention to provide a storage case that is easily transitioned from an open position to a closed position, and thus quickly deployed in a vehicle. As briefly described above, one embodiment of the present invention utilizes a plurality of straps for interconnection to at least one seat of a vehicle. One embodiment of the present invention is deployed such that the entertainment device is situated inside the base portion of the device wherein, upon opening of the storage device, the screen may be viewed easily. In addition, one embodiment of the present invention is provided with at least two gussets situated on either side of the entertainment device to provide support between the closure portion and the base portion and to also to provide locations for the interconnection of suspension straps. Furthermore, the gussets may be utilized for lateral support for the entertainment device.

It is still yet another aspect of the present invention to provide a storage case for entertainment devices that is constructed of commonly used materials and easy to manufacture, thus inexpensive to make. One embodiment of the present invention is constructed of a compliant material, such as leather, polyester, neoprene, nylon, cloth, or a combination thereof. Alternatively, another embodiment of the present invention may be constructed of at least partially rigid materials, such as hard plastic, to provide increased protection to the contents therein. The compliant materials may be stitched onto each other to provide a series of panels and compartments. The present invention may also include a series of ventilation panels, or utilize heat resistant materials, to allow for heat often generated by electronic equipment to be dissipated to prevent overheating of the entertainment device or heat damage to the storage case.

It is yet another aspect of the present invention to provide a novel interconnection system which allows the entertainment storage device to be removably interconnected to a rear portion of the seat, or alternatively to be positioned between two seats. More specifically, the buckle system comprises a strap or other similar mechanism that is interconnected to a headrest or the upper portion of the seat and/or a seat framework on the lower portion. Alternatively, the strap or attachment hardware may be wrapped around an upper portion of the seat for interconnection purposes and securely tightened. Thus, the strap and associated interconnection system may be retained in place while the case for the entertainment storage device is removably interconnected at will.

It is a further aspect of the present invention to provide an orientation mechanism, wherein the storage case for the DVD player or other electronic device may be selectively oriented at a preferred angle to aid in viewing the entertainment device. More specifically, an upper buckle and a lower buckle are provided that are adapted to slide up and down the strap. By positioning the buckles at a preferred location, and snapping the buckles to two interconnection clips interconnected to the storage case, the case may be oriented at a preferred angle (α) to allow proper viewing. For adjustment purposes, the buckles are slid up and down the strap mechanism to a preferred height. To remove the storage case from the strap, the interconnection clips are merely disconnected from the upper buckle and lower buckle. Furthermore, the storage case may be quickly disconnected from the strap mechanism to allow portable transportation when the storage case is not in use within the vehicle and is more like an attache or player case holder.

It is a further aspect of the present invention to provide a case for an entertainment storage device that has one or more line-out devices which allows headphones, power chords, and other accessory items to be selectively interconnected to the case without requiring the case to be opened and which allows access to the headphone ports, USB ports, or other outlets. Preferably the case has dual line-out jacks for headphones, and another line-out jack for power supply.

It is another aspect of the present invention to provide an internal harness mechanism that secures the entertainment device within the storage case. More specifically, in one embodiment the internal harness is designed wherein a portion of the straps are exposed externally on the case, and thus allow tightening while the storage case is closed and which allows for easy access rather than providing an internal harness mechanism which is difficult to access. Preferably, a portion of the straps that are located externally on the storage case include a hook and loop material, buckle or other means well known in the art which can be used to selectively adjust and release the internal harness. Furthermore, in another embodiment of the present invention, the viewing screen of the entertainment storage device such as a DVD is provided to slip under one or more tabs or gussets to help secure the storage screen in an upright position during use, and to prevent excessive movement.

Thus, it is one aspect of the present invention to provide a storage case adapted for interconnection to at least one seat and for securing an entertainment device, comprising:

a container section sized to hold an electronics device;

a means for opening said container section;

an internal harness adapted to secure the DVD player within said container section; and

an external harness interconnected to said container section which is adapted for removable interconnection to a vehicle seat, said external harness comprising an orientation means which allows the adjustment of said container section or a preferred viewing angle.

The Summary of the Invention is neither intended nor should it be construed as being representative of the full extent and scope of the present invention. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these embodiments.

FIG. 1A is a front elevation view of one embodiment of the present invention;

FIG. 1B is a rear elevation view of one embodiment of the present invention;

FIG. 1C is a top plan view of one embodiment of the present invention;

FIG. 1D is a right elevation view of one embodiment of the present invention;

FIG. 2 is a front perspective view showing one embodiment of the present invention and identifying an entertainment player device positioned therein;

FIG. 3 is a front perspective view of one embodiment of the present invention and showing the straps and buckle system used to interconnect the player case behind the seat of a vehicle;

FIG. 4 is a perspective view of the buckle and strap system used for interconnection to the rear portion of a vehicle seat;

FIG. 5 is a front perspective view showing the player case selectively interconnected to the buckle mechanism and interconnected to the rear of a vehicle seat;

FIG. 6 is a left elevation view showing the player case interconnected to the rear portion of a vehicle seat and showing a preferred angle of inclination to facilitate viewing; and

FIG. 7 is a rear perspective view showing the upper buckle opened and in position for receiving the buckle interconnection clip in one embodiment of the present invention.

To assist in the understanding of the present invention the following list of components and associated numbering found in the drawings is provided herein:

| Component | # |
|---|---|
| Storage device | 2 |
| Vehicle seat | 4 |
| Base portion | 6 |
| Closure portion | 8 |
| Strap | 10 |
| Internal restraint member | 14 |
| Entertainment device | 18 |
| Upper buckle | 20 |
| Lower buckle | 22 |
| Buckle interconnection clip | 24 |
| Internal harness | 26 |
| Harness external adjustment | 28 |
| member | |
| Strap | 30 |
| Line out port | 32 |
| External storage compartment | 34 |
| Handle | 36 |
| Headrest | 38 |
| Seat interconnection member | 40 |
| Internal storage compartment | 42 |
| Zipper | 44 |
| Buckle receiving port | 46 |
| Buckle handle | 48 |
| Angle of inclination | α |

It should be understood that the drawings are not necessarily to scale. In certain instances, details which are not necessary for an understanding of the invention or which render other details difficult to perceive may have been omitted for clarity. It should be understood that the invention is not necessarily limited to the particular embodiments illustrated herein.

### DETAILED DESCRIPTION

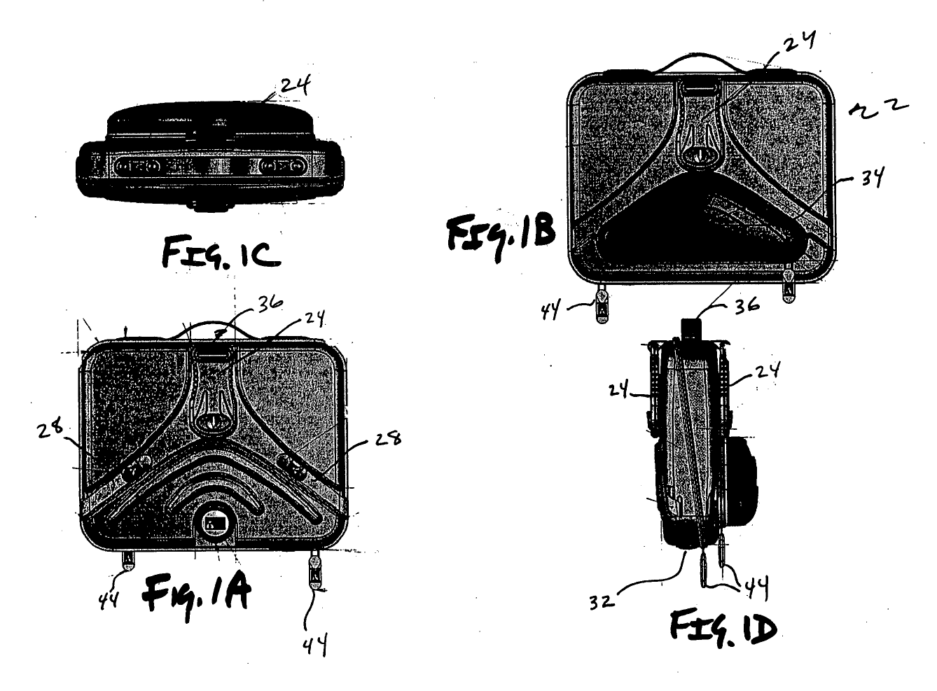

Referring now to FIGS. 1-7, an entertainment device storage case 2 adapted for interconnection to one or more vehicle seats 4 is generally shown herein. More specifically, one embodiment of the present invention includes a base portion 6, a closure portion 8, and one or more straps 10 selectively interconnected thereto for interconnection to at least one seat 4 of a vehicle. Another embodiment of the present invention also includes one or more external pockets 34 integrated into the base portion 6, the closure portion 8, or both. A securing strap 10 may be used in conjunction with the base or closure portion 6 of the storage case 2 to ensure that the entertainment device 18 remains secured to the vehicle seat during use and transportation. More specifically, an upper buckle 20 and a lower buckle 22 are used in one embodiment to allow the storage case to be selectively moved to a preferred vertical position, and to allow the case to be selectively oriented to a preferred viewing position.

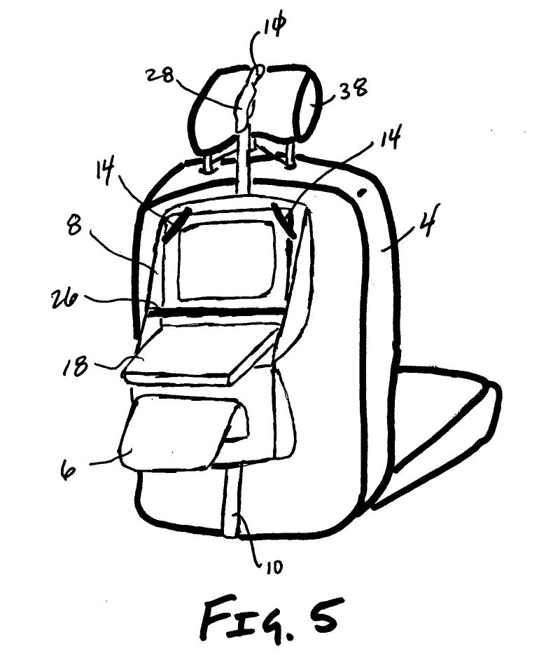

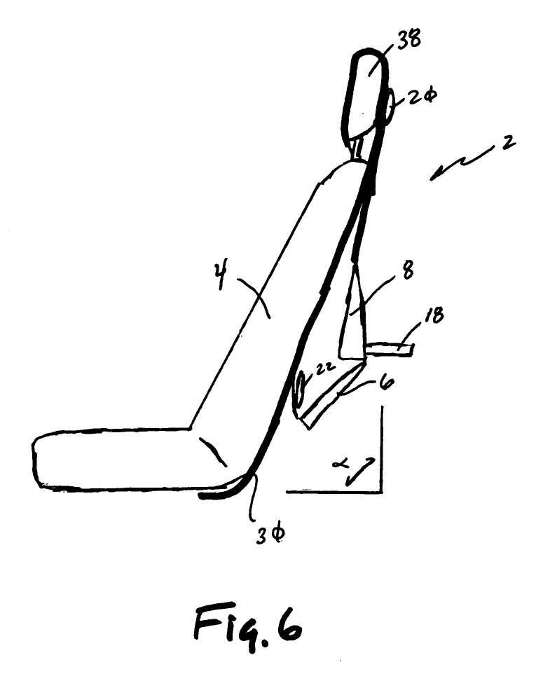

In operation, the base portion 6 and closure portion 8 in one embodiment of the present invention receives and secures the entertainment device 18. The entertainment device 18 is generally retained within the storage device 2 with an internal harness 26 which in one embodiment has one or more external adjustment members 28 which are positioned on an exterior surface of the storage device 2 and thus retain the entertainment device 18 in a secure position. Once the entertainment device 18 is positioned within the storage device 2 the storage device 2 can be carried to a preferred location with the use of a handle 36. When the entertainment device 2 is desired for use in a vehicle, a strap 10 is secured to the vehicle seat 4. The upper buckle 20 and lower buckle 22 may be positioned at any desired vertical height on the vehicle seat 4 to provide ease of viewing for a viewer seated in the back seat of the vehicle. Once the storage device 2 is opened to permit viewing of the entertainment device 18, the buckle interconnection clip is interconnected to the upper buckle and lower buckle and the lower buckle 22 positioned in a way wherein the inclination of the storage device 2 is in a preferred position as shown in FIGS. 5 and 6, and is oriented at an angle α to provide viewing at a preferred angle of inclination. Since the base portion 6 is pulled away from the closure portion 8 at the hinge point, the design allows significantly more air flow than enclosed designs, and thus allows greater cooling to the DVD player or other entertainment device.

Referring now to FIG. 1, a front elevation, rear elevation, right elevation and top plan view of one embodiment of the present invention is provided herein. More specifically, the storage device 2 of the present invention generally includes a base portion 6, a closure portion 8 which is operably interconnected with a zipper 44 or other interconnection means such as Velcro@, buckles, or other means commonly known in the art. As shown in the rear elevation view, the storage device 2 may further include one or more external storage compartments 34 which can be used to retain headsets, additional batteries, and other ancillary items used in combination with the storage device 2. Furthermore, the storage device 2 includes a buckle interconnection clip positioned on both the base portion 6 and closure portion 8 which is adapted for use with a strap 10 and upper buckle 20 and lower buckle 22 which are used for operable interconnection to a vehicle seat and headrest.

Furthermore, in one embodiment of the present invention, one or more “line-out” ports 32 are provided in one or more locations on the storage device 2 and which allows for a headset, USB cable, power cord or other device to be interconnected to the DVD player without opening the player case 2. As further seen on the front elevation view of FIG. 1, one or more harness external adjustment members 28 are provided and which are interconnected to an internal harness 26 positioned on an interior portion of the storage device 2, and which is used to retain the entertainment device 18 securely to the closure portion 8 of the storage device 2.

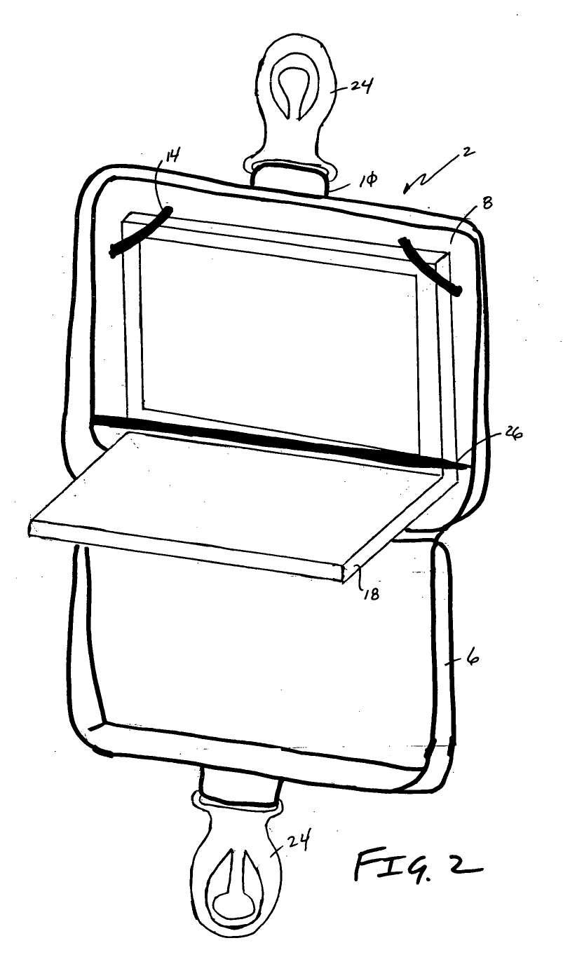

Referring now to FIG. 2, one embodiment of the present invention is shown herein with the closure portion 8 opened from the base portion 6 to reveal the entertainment device 18. More specifically, the entertainment device 18 is retained within the storage device 2 in one embodiment with internal restraint member that are positioned along the upper corners of the entertainment device, and which is further secured by the internal harness 26. As previously discussed in one embodiment, the internal harness 26 has two ends which extend to an outer surface of the closure portion 8, and which includes a means for selectively securing and releasing the internal harness 26 by the use of buckles, Velcro®, and other tightening means well known in the art. Preferably the internal harness 26 is comprised of a band of material comprised of cloth, nylon, elastic, webbing, or other materials well known in the art which can securely retain the entertainment device 18 within the storage device 2. Alternatively, the internal harness 26 may not include portions which extend outside the storage device, and which is merely tightened when the storage device 2 is opened.

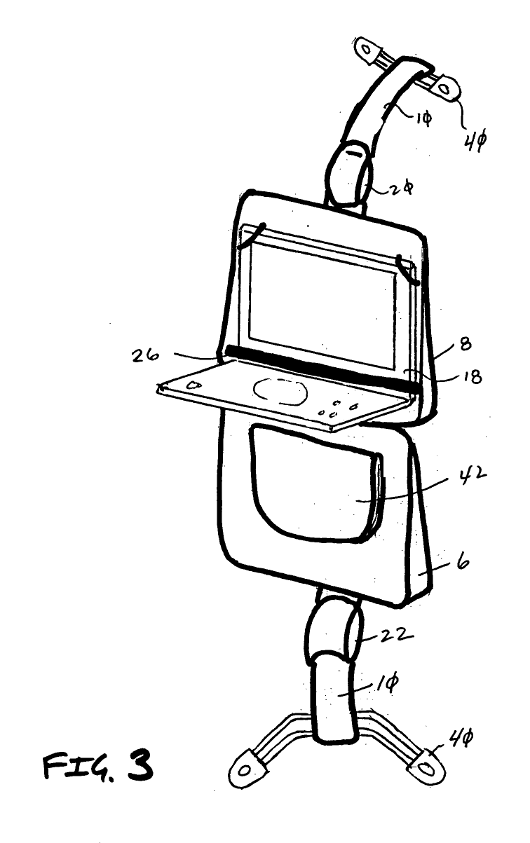

As further shown in FIG. 2, the storage device 2 utilizes a buckle interconnection clip 24 on both the base portion and the closure portion 8, which is adapted for selective interconnection to the upper buckle 20 and lower buckle 22, respectively, as shown in FIG. 3. More specifically, and referring now to FIG. 3, the storage device 2 is shown in an extended position wherein the buckle interconnection clips 24 are selectively interconnected to the upper buckle 20 and lower buckle 22. As shown, both the upper buckle 20 and lower buckle 22 are slidingly interconnected to a strap 10 which is adapted for interconnection to the rear of a vehicle seat 4 and/or headrest. As shown, the strap 10 may further be interconnected to seat interconnection members 40 which may be utilized to interconnect to the post extending from the headrest, or which may utilize hooks, buckles, straps, Velcro®, or other means well known in the art to secure the strap 10 to the seat, headrest, or framework which holds the vehicle seat (not shown). As further shown in FIG. 3, an internal storage compartment 42 is provided in one embodiment of the present invention, and which may be used to store additional DVDs and other accessory items. In one embodiment, the internal storage compartment 42 is selectively interconnected with a hook and closure material or other means wherein the internal storage compartment 42 may be selectively removed from the storage device 2 and carried to a secondary location.

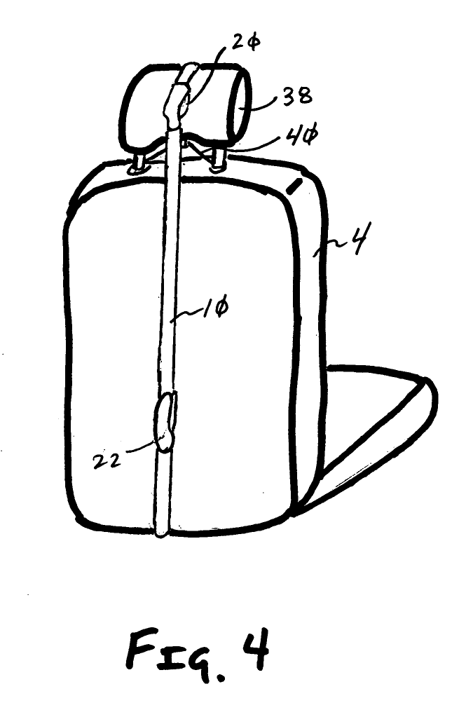

Referring now to FIG. 4, a strap and buckle mechanism utilized in one embodiment of the present invention is provided herein. More specifically, the strap 10 is shown positioned along the rear portion of a vehicle seat 4, and which is interconnected to the vehicle headrest 38 by means of a seat interconnection member 40. The lower portion of the strap 10 is interconnected to either the vehicle seat 4 or the seat framework (not shown). As shown in FIG. 4, an upper buckle 20 and a lower buckle 22 are utilized which may be slid in a vertical direction along the strap 10 to a preferred location. Alternatively the buckle and strap assembly may be utilized for interconnection in a horizontal orientation, and thus allow for selective adjustment in a horizontal or vertical plane.

Referring now to FIG. 5, one embodiment of the storage device 2 of the present invention is shown interconnected to the upper buckle 20 and lower buckle 22 wherein the storage device 2 is securely interconnected to the rear portion of a vehicle seat 4. More specifically, the closure portion 8 is opened from the base portion 6 to allow viewing of the entertainment device 18, which is secured in place by use of one or more internal gussets 14 and the internal harness 26.

Referring now to FIG. 6, the storage device 2 of the present invention is shown in a left elevation view interconnected to the vehicle seat 4. More specifically, after the upper buckle 20 and lower buckle 22 are positioned to a preferred vertical location, the buckle interconnection clips are interconnected to the upper buckle 20 and lower buckle 22, respectively. Depending on the positioning of the lower buckle 22, there is sufficient rigidity in the closure portion 8 and base portion 6 of the storage device 2 to allow an angle α to be formed which positions the storage device 2 in a preferred location wherein the viewing screen is in a substantially vertical position or as preferred by a user. As further shown in FIG. 6, the base portion 6 swings about a hinge portion of the storage device 2 and is thus freely movable to a preferred position and for interconnection to the lower buckle 22. As appreciated by one skilled in the art, without the novel buckle, strap and interconnection system, the player case and associated DVD player could not be positioned at a preferred orientation. The preferred angle of use is provided herein and is identified as α, which is generally about 60-120 degrees. More specifically, once the buckle interconnecting clip is interconnected to the lower buckle 22, the storage device 2 may be oriented at a preferred location wherein the entertainment device 18 is positioned for optimum viewing by a user seated in the back seat of a vehicle.

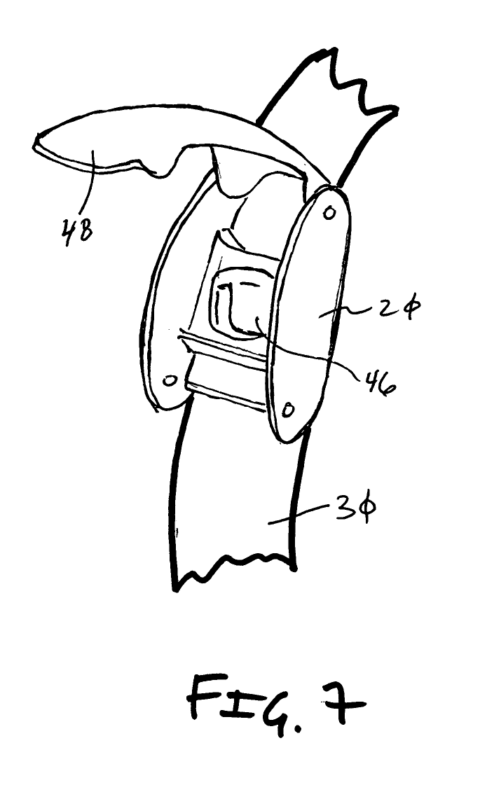

Referring now to FIG. 7, a close-up view of the strap 10 and upper buckle mechanism 20 is provided. More specifically, the upper buckle 20 is shown with the buckle handle 48 which can be selectively closed and/or opened and that includes a buckle receiving port 46 that is used for the interconnection of the buckle interconnection clip. The lower buckle similar to that shown but is reversed, i.e., upside-down, during use. In operation with both the upper buckle 20 and lower buckle, the buckle handle 48 is opened to provide access to the buckle receiving port 46 which is utilized to receive the buckle interconnection clip 24. To release the buckle interconnection clip from the buckle receiving port 46, the upper portion of the buckle interconnection clip is depressed, therein allowing removal from the buckle receiving port 46.

Referring again to FIGS. 1-7, a manner of making one embodiment of the present invention is shown and described herein. Preferably, one embodiment of the present invention is constructed of compliant material, thus making it soft and less likely to cause injury if a strap 10 should fail, for example. Furthermore, EVA foams and other more rigid materials may be used alone or in combination with nylon, cloth, polyethylene, polypropylene, etc. However, one skilled in the art will appreciate that the entire storage device 2, or portions thereof, may be constructed of rigid materials to increase structural strength, for example. The compliant materials used in one embodiment of the present invention may further include leather, nylon, polyester, cloth, plastic, or combinations therein.

While various embodiment of the present invention have been described in detail, it is apparent that modifications and alterations of those embodiments will occur to those skilled in the art. However, it is to be expressly understood that such modifications and alterations are within the scope and spirit of the present invention, as set forth in the following claims.

What is claimed is:

1. An adjustable DVD player case adapted for use in a vehicle, comprising:
a container section sized to hold an electronics device;
a means for opening said container section;
an internal harness adapted to secure the DVD player within said container section; and
an external harness interconnected to said container section which is adapted for removable interconnection to a vehicle seat, said external harness comprising an orientation means which allows the adjustment of said container section to a preferred viewing angle.

2. The adjustable DVD player case of claim 1, wherein said external harness comprises an upper buckle and a lower buckle interconnected to a strap, each of said buckles further comprising an interconnection means for removably interconnecting said container section to at least one of said upper buckle and said lower buckle.

3. The DVD player case of claim 1, wherein said container section is comprised of a base portion and a closure portion.

4. The DVD player case of claim 1, wherein said means for opening comprises at least one of a zipper, a buckle and a hook and loop material.

5. The DVD player case of claim 2, wherein said orientation means comprises interconnecting said base section to said lower buckle at a preferred height and said closure section to said upper buckle at a preferred height.

6. The DVD player case of claim 1, wherein at least a portion of said internal harness extends to an exterior portion of said container.

7. The DVD player case of claim 6, further comprising at least one of a hook and loop material and a buckle interconnected to said internal harness for selectively securing and releasing said internal harness to an exterior portion of said container.

8. The DVD player case of claim 1, further comprising a line-out jack positioned on a portion of said container which is adapted to receive a headset cord or other electronics line.

9. The DVD player case of claim 1, wherein a first buckle interconnection clip is interconnected to said closure portion of said container and a second buckle interconnection clip is interconnected to said base portion of said container.

10. The DVD player case of claim 9, wherein a first buckle interconnection clip is interconnected to said closure portion of said container and a second buckle interconnection clip is interconnected to said base portion of said container.

11. The DVD player case of claim 1, wherein said external harness comprises a strap interconnected on a first end to the vehicle seat or headrest, and a second end interconnected to a lower portion of said vehicle seat or framework supporting the seat.

12. The DVD player case of claim 2, wherein said upper buckle and said lower buckle are adapted for sliding engagement along the strap to a preferred position of use.

13. The DVD player case of claim 1, further comprising a second external harness adapted for removable interconnection to a second vehicle seat.

14. The DVD player case of claim 1, further comprising a removable internal storage compartment which is operably interconnected to an internal portion of said container section

15. An adjustable DVD player case adapted for selective interconnection to a vehicle seat, comprising:
a base portion;
a closure portion hingedly interconnected to said base portion;
a closure means for selectively opening and closing said closure portion to said base portion;
an internal restraint device interconnected to at least one of said base portion and said closure portion which is adapted to secure the DVD player to said closure portion;
a first interconnection mechanism attached to said base portion and a second interconnection portion attached to said closure portion which are adapted for removable interconnection to a strap mechanism secured to the vehicle seat, wherein the vertical position and orientation of at least the closure portion may be selectively adjusted by moving the player case along the strap mechanism.

16. The adjustable player case of claim 15, wherein said first interconnection mechanism and said second interconnection mechanism comprise a buckle.

17. The adjustable player case of claim 15, wherein said strap mechanism further comprises a mechanism which removably interconnects to at least one of said first interconnection mechanism and said second interconnection mechanism.

18. The adjustable player case of claim 15, wherein said orientation of said closure portion is adjustable to allow positioning in a substantially vertical plane.

19. The adjustable player case of claim 15, wherein said closure means comprises a zipper.

20. The adjustable player case of claim 15, wherein said internal restraint device comprises a strap with a hook and loop material.
